(19) United States
(12) Patent Application Publication
(10) Pub. No.: US 2023/0305179 A1
(43) Pub. Date: Sep. 28, 2023

(54) UTILITY LOCATING SYSTEMS AND METHODS WITH FILTER TUNING FOR POWER GRID FLUCTUATIONS

(71) Applicant: SeeScan, Inc., San Diego, CA (US)

(72) Inventors: Scott Alexander Powell, San Diego, CA (US); Mark S. Olsson, San Diego, CA (US); Ray Merewether, La Jolla, CA (US)

(21) Appl. No.: 18/162,663

(22) Filed: Jan. 31, 2023

Related U.S. Application Data
(60) Provisional application No. 63/306,088, filed on Feb. 2, 2022.

(51) Int. Cl. G01V 3/08

(52) U.S. Cl. CPC G01V 3/081

(57) ABSTRACT

Systems and methods are provided for locating underground utility equipment. In an exemplary embodiment, the local utility power grid frequency is detected using a bandwidth filter centered around the nominal or expected frequency, for example, 60 Hz in the US, or 50 Hz in Europe. From the actual utility power grid frequency detected, the frequency of one or more harmonics of the detected power grid frequency are calculated, and then the calculated value(s) may be used to tune one or more bandwidth filters, or to further refine a power grid frequency offset enabling detection of a larger range of frequencies. Using the offset, any detected power grid frequencies and desired harmonics may be used by a utility locator or system to increase detection and location accuracy by adjusting for any power grid frequency fluctuations.

### CROSS REFERENCE TO RELATED APPLICATIONS

This application claims priority under 35 U.S.C. § 119(e) to co-pending U.S. Provisional Pat. Application Serial No. 63/306,088 entitled UTILITY LOCATING SYSTEMS AND METHODS WITH FILTER TUNING FOR POWER GRID FLUCTUATIONS filed on Feb. 2, 2022, the content of which is hereby incorporated by reference herein in its entirety for all purposes.

### FIELD

This disclosure relates generally to systems and methods for locating buried or otherwise inaccessible pipes and other conduits, as well as electrical cables, conductors and inserted transmitters, by detecting an electromagnetic signal emitted by these buried objects. More specifically, but not exclusively, this disclosure relates to systems and methods for improving the quality and accuracy of utility locating systems by compensating for any utility power grid frequency fluctuations.

### BACKGROUND

FIG. 1 illustrates a system for detecting and locating underground, buried, or hidden pipes, cables, conductors, or other utility assets, as is known in the prior art. A portable utility locator may be used to detect multifrequency electromagnetic data from buried objects associated with utilities or communication systems. Underground objects may include power lines, electrical lines, gas lines, water lines, cable and television lines, and communication lines. Power and electrical lines may be single phase, three phase, passive, active, low or high voltage, and low or high current. Data collected from various underground objects may be single frequency or multifrequency data.

Accurately locating underground or buried objects often requires detecting an electromagnetic signal emitted by these objects. The quality and strength or amplitude of an emitted signal often determines if the locator can detect or distinguish the electromagnetic signal at all. Many of the prior art locating methods and systems only “look for”, and therefore, have the ability, to detect a very small number of discrete frequencies.

Many currently available locating systems are configured to detect known frequencies. For instance, it would be very common for a typical locating system to look for 60 Hz signals which is the typical Utility Power Grid System operating frequency standard used in the US. This typical or expected operating frequency is also known as the power grid “nominal frequency”. In other countries or regions, the Utility Grid Power System nominal frequency may be a different value. For instance, in Europe the grid nominal frequency is 50 Hz, and in Japan, Saudi Arabia, and South Korea both 50 and 60 Hz frequencies are used.

Available locating methods and systems typically include receiving circuitry for detecting electromagnetic signals in a specific frequency range. A common way to configure a locator’s electronics to detect a specific frequency range is to use one or more readily available bandpass filters. Many types of bandpass filters are available, and well known in the art, which allow signals within a selected range of frequencies (bandwidth of the filter) to be detected.

One might ask why a bandpass filter would be needed to detect a range of frequencies related to the nominal power grid frequency, if the frequency is already known to be a specific value, for instance, 50 or 60 Hz. It is a common misconception that the frequency of the powerline provided by a utility is controlled at any specific moment in time, or even over the course of a day. Most states and countries have specific standards on how much the nominal utility frequency may vary at any time. There are also regional standards that exist in order to allow multiple power grid systems to interact. For instance, one such standard organization is the North American Electric Reliability Corporation (NERC) which sets utility grid frequency tolerance standards for North America. The current NERC standard for the US is +/- 5% from the nominal 60 Hz frequency.

The reason there is a tolerance range is because of the way a typical 3ϕ (three-phase) Utility Power System interacts with load demand changes caused by transformers, power factor (PF) leveling capacitors, 3ϕ motors, electrical machinery, air conditioning heat pumps, lighting, and other electrical equipment. When demand is high, e.g. first thing in the morning when people wake up and use more lights, appliances, etc., when workers arrive at work and large machines are put on-line, in the summer when more AC is used, and in the winter when more electrical heating is used, etc., demand is increased. In the evening, and during times of more temperate weather, the demands on the Power Grid are often reduced. These changes can cause swings in the nominal frequency that are both within and beyond expected frequency ranges.

Specific frequencies, as well as multiples or harmonics of those frequencies, typically have the most energy (higher amplitudes), and a higher quality (better signal to noise ratio) in those bands making them more easily detectable by utility locators, than other less desirable frequencies. For instance, in some cities lower band frequencies such as 60 Hz, 540 Hz (9th harmonic), and 900 Hz (15th harmonic), can be easily detected.

Harmonics are a natural effect of a periodic signal which is not purely sinusoidal. In power systems, the harmonics can be produced by things that run off the power grid, for instance, anything that creates a DC signal out of the AC signal, or many other types of electrically powered equipment. Since harmonics exist, and are radiated by utilities, it would be useful to detect them in order to locate the utilities and corresponding equipment. One advantage to having the ability to detect harmonics is that they can be passively located, instead of actively whereby an external signal would need to be introduced into the system in order to facilitate detection of utility system assets.

Many times, signals at higher harmonics have higher energy available, and can be more easily detected than signals at lower harmonics. It is, therefore, often desirable to detect a wide range of harmonic frequencies in order to locate and distinguish a wide range of utility assets.

Most utility locators and systems in the art look for a small, finite number of frequencies. Many times the number of frequencies searched for is as low as 3 or 4. It would be impossible, as well as impractical, to configure a locating system to look for and detect an infinite number and range of Utility Power System frequencies and their harmonics. Furthermore, as the Power Grid frequency fluctuates, filters configured to detect signals at higher frequencies, e.g. at frequencies up to the 200th harmonic or higher (approximately 12 kHz), may not be able to detect any signal because the bandwidth of the filter may now be out of range for detecting a signal with enough energy to be useful.

As an example, it may be desired to detect a nominal power grid frequency of 60 Hz. One way to accomplish this could be to use a bandpass filter configured with a center frequency (f₀) of 60 Hz, and a bandwidth of 2 Hz. This particular filter configuration would allow the detection of frequencies in the range of 59 Hz to 61 Hz. If with this filter the detected actual power grid frequency is 60.25 Hz, the filter would be able to detect the signal. Since the offset is only 0.25 Hz, it might be assumed that a second bandpass filter set to detect the 60 Hz nominal power grid frequency at a higher harmonic, for instance the 200th harmonic, would also be able to detect the signal if it was configured with the same bandwidth, this would be wrong. A second filter configured with a frequency (f₀) of 12 kHz (60 Hz x 200), and a 2 Hz bandwidth would not be able to detect the actual power grid frequency harmonic. The error, or offset, at 60 Hz is 0.25 Hz or about 0.42% of the nominal power grid frequency. Even though the percentage error would be approximately the same at higher harmonics, the actual offset value is multiplied by the harmonic. At 12 kHz, the 200th harmonic, the offset would be 0.25 × 200, or 50 Hz. Since the second bandpass filter in this example is configured with only a 2 Hz bandwidth, it would not be able to detect the actual power grid frequency signal at the higher harmonic because the 50 Hz offset would be out of the range of the second filter.

The way this problem has been dealt with by locating systems and methods in the past has been basically to ignore the problem, thereby, preventing a large range of signals, especially at higher harmonics, to be detected.

What is needed in the art is a utility locating system and method with the ability to detect a large number and range of frequencies consistently and accurately by continuously compensating for any utility power grid frequency fluctuations.

Accordingly, the present invention is directed towards addressing the above-described problems and other problems associated with utility locating systems and methods which are used for detecting electromagnetic signals emitted by buried and/or underground utility obj ects.

### SUMMARY

This disclosure relates generally to utility locating systems and methods. More specifically, but not exclusively, this disclosure relates to systems and methods for improving the quality and accuracy of utility locating systems by compensating for any utility power grid frequency fluctuations.

In another aspect, this disclosure relates to systems and methods for monitoring a nominal, or typically expected power grid frequency provided by an electric utility power company, detecting the actual power grid frequency at a specific moment in time, and if the nominal power grid frequency and the actual power grid frequency are different, determining a filter offset for tuning one or more filter. The tuned filters will then provide more accurate frequency tracking, and in turn will allow the locator to provide more accurate and precise locating of underground or buried utility assets.

In another aspect, this disclosure relates to improving the accuracy and precision of utility locating systems by creating a historical record of the actual power grid frequencies detected including data related to location, time, and electromagnetic signal amplitude, and iteratively resetting the bandwidth of one or more band pass filters, thereby creating a filter offset to adjust for fluctuations in the nominal power grid frequency.

In another aspect, this disclosure relates to improving the accuracy and precision of utility locating systems by monitoring the nominal power grid frequency using a low side bandpass filter and high side bandpass filter, calculating the ratio of received electromagnetic amplitude of between the two filters, and using the ratio to accurately determine the actual power grid frequency.

Various additional aspects, features, and functions are describe below in conjunction with the Drawings.

Details of example devices, systems, and methods that may be combined with the embodiments disclosed herein, as well as additional components, methods, and configurations that may be used in conjunction with the embodiments described herein, are disclosed in co-assigned patents and patent applications including: U.S. Pat. 7,009,399, issued Mar. 7, 2006, entitled OMNIDIRECTIONAL SONDE AND LINE LOCATOR; U.S. Pat. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S Pat.7,221,136, issued May 22, 2007, entitled SONDES FOR LOCATING UNDERGROUND PIPES AND CONDUITS; U.S Pat. 7,276,910, issued Oct. 2, 2007, entitled A COMPACT SELF-TUNED ELECTRICAL RESONATOR FOR BURIED OBJECT LOCATOR APPLICATIONS; U.S. Pat. 7,288,929, issued Oct. 30, 2007, entitled INDUCTIVE CLAMP FOR APPLYING SIGNAL TO BURIED UTILITIES; U.S. Pat. 7,298,126, issued Nov. 20, 2007, entitled SONDES FOR LOCATING UNDERGROUND PIPES AND CONDUITS; U.S. Pat. 7,332,901, issued Feb. 19, 2008, entitled LOCATOR WITH APPARENT DEPTH INDICATION; U.S. Pat. 7,443,154, issued Oct. 28, 2008, entitled MULTI-SENSOR MAPPING OMNIDIRECTIONAL SONDE AND LINE LOCATOR; U.S. Pat. 7,498,797, issued Mar. 3, 2009, entitled LOCATOR WITH CURRENT-MEASURING CAPABILITY; U.S. Pat. 7,498,816, issued Mar. 3, 2009, entitled OMNIDIRECTIONAL SONDE AND LINE LOCATOR; U.S. Pat. 7,336,078, issued Feb. 26, 2008, entitled MULTI-SENSOR MAPPING OMNIDIRECTIONAL SONDE AND LINE LOCATORS; U.S. Pat. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. 7,557,559, issued Jul. 7, 2009, entitled COMPACT LINE ILLUMINATOR FOR BURIED PIPES AND CABLES; U.S. Pat. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat.ent 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat.7,741,848, issued Jun. 22, 2010, entitled ADAPTIVE MULTICHANNEL LOCATOR SYSTEM FOR MULTIPLE PROXIMITY DETECTION; U.S. Pat. 7,755,360, issued Jul. 13, 2010, entitled PORTABLE LOCATOR SYSTEM WITH JAMMING REDUCTION; U.S. Pat.ent 7,825,647, issued Nov. 2, 2010, entitled METHOD FOR LOCATING BURIED PIPES AND CABLES; U.S. Pat. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. 7,864,980, issued Jan. 4, 2011, entitled SONDES FOR LOCATING UNDERGROUND PIPES AND CONDUITS; U.S. Pat. 7,948,236, issued May 24, 2011, entitled ADAPTIVE MULTICHANNEL LOCATOR SYSTEM FOR MULTIPLE PROXIMITY DETECTION; U.S. Pat. 7,969,151, issued Jun. 28, 2011, entitled PRE-AMPLIFIER AND MIXER CIRCUITRY FOR A LOCATOR ANTENNA; U.S. Pat. 7,990,151, issued Aug. 2, 2011, entitled TRI-POD BURIED LOCATOR SYSTEM; U. S. Pat. 8,013,610, issued Sep. 6, 2011, entitled HIGH Q SELF-TUNING LOCATING TRANSMITTER; U.S. Pat. 8,035,390, issued Oct. 11, 2011, entitled OMNIDIRECTIONAL SONDE AND LINE LOCATOR; U.S. Pat. 8,106,660, issued Jan. 31, 2012, entitled SONDE ARRAY FOR USE WITH BURIED LINE LOCATOR; U.S. Pat. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. Pat. Application 13/769,202, filed Feb. 15, 2013, entitled SMART PAINT STICK DEVICES AND METHODS; U.S. Pat. Application 13/793,168, filed Mar. 11, 2013, entitled BURIED OBJECT LOCATORS WITH CONDUCTIVE ANTENNA BOBBINS; U.S. Pat. 8,400,154, issued Mar. 19, 2013, entitled LOCATOR ANTENNA WITH CONDUCTIVE BOBBIN; U.S Pat. Application 14/027,027, filed Sep. 13, 2013, entitled SONDE DEVICES INCLUDING A SECTIONAL FERRITE CORE STRUCTURE; U. S. Pat. Application 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. 8,547,428, issued Oct. 1, 2013, entitled PIPE MAPPING SYSTEM; U.S. Pat. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANE-OUDLY INDICATING THE DIFFERENT LOCATIONS TO A USER; U.S. Pat. Application 14/148,649, filed Jan. 6, 2014, entitled MAPPING LOCATING SYSTEMS & METHODS; U.S. Pat. 8,635,043, issued Jan. 21, 2014, entitled LOCATOR AND TRANSMITTER CALIBRATION SYSTEM; U.S. Pat. 8,717,028, issued May 6, 2014, entitled SPRING CLIPS FOR USE WITH LOCATING TRANSMITTERS; U.S. Pat.8,773,133, issued Jul. 8, 2014, entitled ADAPTIVE MULTICHANNEL LOCATOR SYSTEM FOR MULTIPLE PROXIMITY DETECTION; U.S. Pat. 8,841,912, issuedSep. 23, 2014, entitled PRE-AMPLIFIER AND MIXER CIRCUITRY FOR A LOCATOR ANTENNA; U.S. Pat. 9,041,794, issued May 26, 2015, entitled PIPE MAPPING SYSTEMS AND METHODS; U.S. Pat. 9,057,754, issued Jun. 16, 2015, entitled ECONOMICAL MAGNETIC LOCATOR APPARATUS AND METHOD; U.S. Pat. 9,081,109, issued Jul. 14, 2015, entitled GROUND-TRACKING DEVICES FOR USE WITH A MAPPING LOCATOR; U.S. Pat. 9,082,269, issued Jul. 14, 2015, entitled HAPTIC DIRECTIONAL FEEDBACK HANDLES FOR LOCATION DEVICES; U.S. Pat. 9,085,007, issued Jul. 21, 2015, entitled MARKING PAINT APPLICATOR FOR PORTABLE LOCATOR; U.S. Pat. 9,207,350, issued Dec. 8, 2015, entitled BURIED OBJECT LOCATOR APPARATUS WITH SAFETY LIGHTING ARRAY; U.S. Pat. 9,341,740, issued May 17, 2016, entitled OPTICAL GROUND TRACKING APPARATUS, SYSTEMS, AND METHODS; U.S. Pat. 9,372,117, issued Jun. 21, 2016, entitled OPTICAL GROUND TRACKING APPARATUS, SYSTEMS, AND METHODS; U.S. Pat. Application 15/187,785, filed Jun. 21, 2016, entitled BURIED UTILITY LOCATOR GROUND TRACKING APPATUS, SYSTEMS, AND METHODS; U.S. Pat. 9,411,066, issued Aug. 9, 2016, entitled SONDES & METHODS FOR USE WITH BURIED LINE LOCATOR SYSTEMS; U.S. Pat. 9,411,067, issued Aug. 9, 2016, entitled GROUND-TRACKING SYSTEMS AND APPARATUS; U.S. Pat. 9,435,907, issued Sep. 6, 2016, entitled PHASE SYNCHRONIZED BURIED OBJECT LOCATOR APPARATUS, SYSTEMS, AND METHODS; U.S. Pat. 9,465,129, issued Oct. 11, 2016, entitled IMAGE-BASED MAPPING LOCATING SYSTEM; U.S. Pat. 9,488,747, issued Nov. 8, 2016, entitled GRADIENT ANTENNA COILS AND ARRAYS FOR USE IN LOCATING SYSTEM; U.S. Pat. 9,494,706, issued Nov. 15, 2016, entitled OMNI-INDUCER TRANSMITTING DEVICES AND METHODS; U.S. Pat. 9,523,788, issuedDec. 20, 2016, entitled MAGNETIC SENSING BURIED OBJECT LOCATOR INCLUDING A CAMERA; U.S. Pat.9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. 9,599,740, issued Mar. 21, 2017, entitled USER INTERFACES FOR UTILITY LOCATORS; U.S. Pat.9,625,602, issued Apr. 18, 2017, entitled SMART PERSONAL COMMUNICATION DEVICES AS USER INTERFACES; U.S. Pat. 9,632,202, issued Apr. 25, 2017, entitled ECONOMICAL MAGNETIC LOCATOR APPARATUS AND METHODS; U.S. Pat.9,634,878, issued Apr. 25, 2017, entitled SYSTEMS AND METHODS FOR DATA TRANSFER USING SELF-SYNCHRONIZING QUADRATURE AMPLITUDE MODULATION (QAM); U.S. Pat. Application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. 9,638,824, issued May 2, 2017, entitled QUAD-GRADIENT COILS FOR USE IN LOCATING SYSTEMS; U.S. Pat. Application, filed May 9, 2017, entitled BORING INSPECTION SYSTEMS AND METHODS; U.S. Pat. 9,651,711, issued May 16, 2017, entitled HORIZONTAL BORING INSPECTION DEVICE AND METHODS; U.S. Pat. 9,684,090, issued Jun. 20, 2017, entitled NULLED-SIGNAL LOCATING DEVICES, SYSTEMS, AND METHODS; U.S. Pat. 9,696,447, issued Jul. 4, 2017, entitled BURIED OBJECT LOCATING METHODS AND APPARATUS USING MULTIPLE ELECTROMAGNETIC SIGNALS; U.S. Pat. 9,696,448, issued Jul. 4, 2017, entitled GROUND-TRACKING DEVICES AND METHODS FOR USE WITH A UTILITY LOCATOR; U.S. Pat. 9,703,002, issued Jun. 11, 2017, entitled UTILITY LOCATOR SYSTEMS & METHODS; U.S. Pat. Application 15/670,845, filed Aug. 7, 2016, entitled HIGH FREQUENCY AC-POWERED DRAIN CLEANING AND INSPECTION APPARATUS & METHODS; U.S. Pat. Application 15/681,250, filed Aug. 18, 2017, entitled ELECTRONIC MARKER DEVICES AND SYSTEMS; U.S. Pat.Application 15/681,409, filed Aug. 20, 2017, entitled WIRELESS BURIED PIPE & CABLE LOCATING SYSTEMS; U.S. Pat. 9,746,572, issued August 29, 2017, entitled ELECTRONIC MARKER DEVICES AND SYSTEMS; U.S. Pat.9,746,573, issued Aug. 29, 2017, entitled WIRELESS BURIED PIPE AND CABLE LOCATING SYSTEMS; U.S. Pat. 9,784,837, issued Oct. 10, 2017, entitled OPTICAL GROUND TRACKING APPARATUS, SYSTEMS & METHODS; U.S. Pat. Application 15/811,361, filed Nov. 13, 2017, entitled OPTICAL GROUND-TRACKING APPARATUS, SYSTEMS, AND METHODS; U.S. Pat. 9,841,503, issued Dec. 12, 2017, entitled OPTICAL GROUND-TRACKING APPARATUS, SYSTEMS, AND METHODS; U.S. Pat. Application 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. Pat. Application 15/866,360, filed Jan. 9, 2018, entitled TRACKED DISTANCE MEASURING DEVICES, SYSTEMS, AND METHODS; U.S. Pat. 9,891,337, issued Feb. 13, 2018, entitled UTILITY LOCATOR TRANSMITTER DEVICES, SYSTEMS, and METHODS WITH DOCKABLE APPARATUS; U. S. Pat. 9,914,157, issued March, 13, 2018, entitled METHODS AND APPARATUS FOR CLEARING OBSTRUCTIONS WITH A JETTER PUSH-CABLE APPARATUS; U.S. Pat. Application 15/925,643, issued Mar. 19, 2018, entitled PHASE-SYNCHRONIZED BURIED OBJECT TRANSMITTER AND LOCATOR METHODS AND APPARATUS; U. S. Pat. Application 15/925,671, issued Mar. 19, 2018, entitled MULTI-FREQUENCY LOCATING SYSTEMS AND METHODS; U.S. Pat. Application 15/936,250, filed March 26, 208, entitled GROUND TRACKING APPARATUS, SYSTEMS, AND METHODS; U.S. Pat. 9,927,545, issued Mar. 27, 2018, entitled MULTI-FREQUENCY LOCATING SYSTEMS & METHODS; U.S. Pat. 9,928,613, issued Mar. 27, 2018, entitled GROUND TRACKING APPARATUS, SYSTEMS, AND METHODS; U.S. Pat. Application 15/250,666, filed Mar. 27, 2018, entitled PHASE-SYNCHRONIZED BURIED OBJECT TRANSMITTER AND LOCATOR METHODS AND APPARATUS; U.S. Pat. 9,880,309, issued Mar. 28, 2018, entitled UTILITY LOCATOR TRANSMITTER APPARATUS & METHODS; U.S. Pat. Application 15/954,486, filed Apr. 16, 2018, entitled UTILITY LOCATOR APPARATUS, SYSTEMS, AND METHODS; U.S. Pat. 9,945,976, issued Apr. 17, 2018, entitled UTILITY LOCATOR APPARATUS, SYSTEMS, AND METHODS; U.S. Pat. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORHTOGONAL ANTENNAE; U.S. Pat. Application 16/036,713, issued Jul. 16, 2018, entitled UTILITY LOCATOR APPARATUS AND SYSTEMS; U.S. Pat. 10,024,994, issued Jul. 17, 2018, entitled WEARABLE MAGNETIC FIELD UTILITY LOCATOR SYSTEM WITH SOUND FIELD GENERATION; U.S. Pat. 10,031,253, issued Jul. 24, 2018, entitled GRADIENT ANTENNA COILS AND ARRAYS FOR USE IN LOCATING SYSTEMS; U.S. Pat. 10,042,072, issued Aug. 7, 2018, entitled OMNI-INDUCER TRANSMITTING DEVICES AND METHODS; U.S. Pat. 10,059,504, issued Aug. 28, 2018, entitled MARKING PAINT APPLICATOR FOR USE WITH PORTABLE UTILITY LOCATOR; U.S. Pat. Application 16/049,699, filed Jul. 30, 2018, entitled OMNI-INDUCER TRANSMITTING DEVICES AND METHODS; U.S. Pat.10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. Pat. Application 16/121,379, filed Sep. 4, 2018, entitled KEYED CURRENT SIGNAL UTILITY LOCATING SYSTEMS AND METHODS; U.S. Pat. Application 16/125,768, filed Sep. 10, 2018, entitled BURIED OBJECT LOCATOR APPARATUS AND METHODS; U.S. Pat. 10,073,186, issuedSep. 11, 2018, entitled KEYED CURRENT SIGNAL UTILITY LOCATING SYSTEMS AND METHODS; U.S. Pat. Application 16/133,642, issued Sep. 17, 2018, entitled MAGNETIC UTILITY LOCATOR DEVICES AND METHODS; U.S. Pat. 10,078,149, issued Sep. 18, 2018, entitled BURIED OBJECT LOCATORS WITH DODECAHEDRAL ANTENNA NODES; U.S. Pat.10,082,591, issued Sep. 25, 2018, entitled MAGNETIC UTILITY LOCATOR DEVICES & METHODS; U.S. Pat. 10,082,599, issued Sep. 25, 2018, entitled MAGNETIC SENSING BURIED OBJECT LOCATOR INCLUDING A CAMERA; U.S. Pat. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. Pat. Application 16/160,874, filed Oct. 15, 2018, entitled TRACKABLE DIPOLE DEVICES, METHODS, AND SYSTEMS FOR USE WITH MARKING PAINT STICKS; U.S. Pat. Application 16/222,994, filed Dec. 17, 2018, entitled UTILITY LOCATORS WITH RETRACTABLE SUPPORT STRUCTURES AND APPLICATIONS THEREOF; U.S. Pat. 10,105,723, issued Oct. 23, 2018, entitled TRACKABLE DIPOLE DEVICES, METHODS, AND SYSTEMS FOR USE WITH MARKING PAINT STICKS; U.S. Pat. 10,162,074, issued Dec. 25, 2018, entitled UTILITY LOCATORS WITH RETRACTABLE SUPPORT STRUCTURES AND APPLICATIONS THEREOF; U.S. Pat. Application 16/241,864, filed Jan. 7, 2019, entitled TRACKED DISTANCE MEASURING DEVICES, SYSTEMS, AND METHODS; U.S. Pat. Application 16/255,524, filed Jan. 23, 2019, entitled RECHARGEABLE BATTERY PACK ONBOARD CHARGE STATE INDICATION METHODS AND APPARATUS; U.S. Pat. 10,247,845, issued Apr. 2, 2019, entitled UTILITY LOCATOR TRANSMITTER APPARATUS AND METHODS; U.S. Pat. Application 16/382,136, filed Apr. 11, 2019, entitled GEOGRAPHIC MAP UPDATING METHODS AND SYSTEMS; U.S. Pat. 10,274,632, issued Apr. 20, 2019, entitled UTILITY LOCATING SYSTEMS WITH MOBILE BASE STATION; U.S. Pat. Application 16/390,967, filed Apr. 22, 2019, entitled UTILITY LOCATING SYSTEMS WITHMO-BILE BASE STATION; U.S. Pat. Application 29/692,937, filed May 29, 2019, entitled BURIED OBJECT LOCATOR; U.S. Pat. Application 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. 10,317,559, issued Jun. 11, 2019, entitled GROUND-TRACKING DEVICES AND METHODS FOR USE WITH A UTILITY LOCATOR; U.S. Pat. Application 16/449,187, filed Jun. 21, 2019, entitled ELECTROMAGNETIC MARKER DEVICES FOR BURIED OR HIDDEN USE; U.S. Pat. Application 16/455,491, filed Jun. 27, 2019, entitled SELF-STANDING MULTI-LEG ATTACHMENT DEVICES FOR USE WITH UTILITY LOCATORS; U.S. Pat. 10,353,103, issued Jul. 16, 2019, entitled SELF-STANDING MULTI-LEG ATTACHMENT DEVICES FOR USE WITH UTILITY LOCATORS; U.S. Pat. Application 16/551,653, filed Aug. 26, 2019, entitled BURIED UTILITY MARKER DEVICES, SYSTEMS, AND METHODS; U.S. Pat. 10,401,526, issued Sep. 3, 2019, entitled BURIED UTILITY MARKER DEVICES, SYSTEMS, AND METHODS; U.S. Pat. 10,324,188, issued Oct. 9, 2019, entitled OPTICAL GROUND TRACKING APPARATUS, SYSTEMS, AND METHODS FOR USE WITH BURIED UTILITY LOCATORS; U.S. Pat. Application 16/446,456, filed Jun. 19, 2019, entitled DOCKABLE TRIPODAL CAMERA CONTROL UNIT; U.S. Pat. Application 16/520,248, filed Jul. 23, 2019, entitled MODULAR BATTERY PACK APPARATUS, SYSTEMS, AND METHODS; U.S. Pat. 10,371,305, issued Aug. 6, 2019, entitled DOCKABLE TRIPODAL CAMERA CONTROL UNIT; U.S. Pat. 10,490,908, issued Nov. 26, 2019, entitled DUAL ANTENNA SYSTEMS WITH VARIABLE POLARIZATION; U.S. Pat. Application 16/701,085, filed Dec. 2, 2019, entitled MAP GENERATION BASED ON UTILITY LINE POSITION AND ORIENTATION ESTIMATES; U.S. Pat. 10,534,105, issued Jan. 14, 2020, entitled UTILITY LOCATING TRANSMITTER APPARATUS AND METHODS; U.S. Pat. Application 16/773,952, filed Jan. 27, 2020, entitled MAGNETIC FIELD CANCELING AUDIO DEVICES; U.S. Pat. Application 16/780,813, filed Feb. 3, 2020, entitled RESILIENTLY DEFORMABLE MAGNETIC FIELD CORE APPARATUS AND APPLICATIONS; U.S. Pat. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. Pat. Application 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. Pat. Application 16/791,979, issued Feb. 14, 2020, entitled MARKING PAINT APPLICATOR APPARATUS; U.S. Pat. Application 16/792,047, filed Feb. 14, 2020, entitled SATELLITE AND MAGNETIC FIELD SONDE APPARATUS AND METHODS; U.S. Pat.10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. 10,569,952, issued Feb. 25, 2020, entitled MARKING PAINT APPLICATOR FOR USE WITH PORTABLE UTILITY LOCATOR; U.S. Pat. Application 16/810,788, filed Mar. 5, 2019, entitled MAGNETICALLY RETAINED DEVICE HANDLES; U.S. Pat. Application 16/827,672, filed Mar. 23, 2020, entitled DUAL ANTENNA SYSTEMS WITH VARIABLE POLARIZATION; U.S. Pat. Application 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. 10,608,348, issued Mar. 31, 2020, entitled DUAL ANTENNA SYSTEMS WITH VARIABLE POLARIZATION; U.S. Pat. Application 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. Pat. Application 17/235,507, filed Apr. 20, 2021, entitled UTILITY LOCATING DEVICES EMPLOYING MULTIPLE SPACED APART GNSS ANTENNAS; U.S. Provisional Pat. Application 63/015,692, filed Apr. 27, 2020, entitled SPATIALLY AND PROCESSING-BASED DIVERSE REDUNDANCY FOR RTK POSITIONING; U.S. Pat. Application 16/872,362, filed May 11, 2020, entitled BURIED LOCATOR SYSTEMS AND METHODS; U.S. Pat. Application 16/882,719, filed May 25, 2020, entitled UTILITY LOCATING SYSTEMS, DEVICES, AND METHODS USING RADIO BROADCAST SIGNALS; U.S. Pat. 10,670,766, issued Jun. 2, 2020, entitled UTILITY LOCATING SYSTEMS, DEVICES, AND METHODS USING RADIO BROADCAST SIGNALS; U. S. Pat. 10,677,820, issued Jun. 9, 2020, entitled BURIED LOCATOR SYSTEMS AND METHODS; U.S. Pat. Application 16/902,245, filed Jun. 15, 2020, entitled LOCATING DEVICES, SYSTEMS, AND METHODS USING FREQUENCY SUITES FOR UTILITY DETECTION; U.S. Pat. Application 16/902,249, filed Jun. 15, 2020, entitled USER INTERFACES FOR UTILITY LOCATORS; U.S. Pat. 10,690,795, issued Jun. 23, 2020, entitled LOCATING DEVICES, SYSTEMS, AND METHODS USING FREQUENCY SUITES FOR UTILITY DETECTION; U.S. Pat. Application 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. 10,690,796, issued Jun. 23, 2020, entitled USER INTERFACES FOR UTILITY LOCATORS; U.S. Pat. Application 16/921,775, filed Jul. 6, 2020, entitled AUTO-TUNING CIRCUIT APPARATUS AND METHODS; U.S. Provisional Pat. Application 63/055,278, filed Jul. 22, 2020, entitled VEHICLE-BASED UTILITY LOCATING USING PRINCIPAL COMPONENTS; U.S. Pat. Application 16/995,801, filed Aug. 17, 2020, entitled UTILITY LOCATOR TRANSMITTER DEVICES, SYSTEMS, AND METHODS; U.S. Pat. Application 17/001,200, filed Aug. 24, 2020, entitled MAGNETIC SENSING BURIED UTLITITY LOCATOR INCLUDING A CAMERA; U.S. Pa.16/995,793, filed Aug. 17, 2020, entitled UTILITY LOCATOR APPARATUS AND METHODS; U.S. Pat. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. 10,754,053, issued Aug. 25, 2020, entitled UTILITY LOCATOR TRANSMITTER DEVICES, SYSTEMS, AND METHODS WITH DOCKABLE APPARATUS; U.S. Pat. 10,761,233, issued Sep. 1, 2020, entitled SONDES AND METHODS FOR USE WITH BURIED LINE LOCATOR SYSTEMS; U.S. Pat. 10,761,239, issued Sep. 1, 2020, entitled MAGNETIC SENSING BURIED UTILITY LOCATOR INCLUDING A CAMERA; U.S. Pat.Application 17/013,831, filed Sep. 7, 2020, entitled MULTIFUNCTION BURIED UTILITY LOCATING CLIPS; U.S. Pat. 10,777,919, issued Sep. 15, 2020, entitled MULTIFUNCTION BURIED UTILITY LOCATING CLIPS; U.S. Pat. Application 17/020,487, filed Sep. 14, 2020, entitled ANTENNA SYSTEMS FOR CIRCULARLY POLARIZED RADIO SIGNALS; U.S. Pat. Application 17/068,156, filedOct. 12, 2020, entitled DUAL SENSED LOCATING SYSTEMS AND METHODS; U.S. Provisional Pat. Application 63/091,67, filed Oct. 14, 2020, entitled ELECTRONIC MARKER-BASED NAVIGATION SYSTEMS AND METHODS FOR USE IN GNSS-DEPRIVED ENVIRONMENTS; U.S. Pat. 10,809,408, issued Oct. 20, 2020, entitled DUAL SENSED LOCATING SYSTEMS AND METHODS; U.S. Pat. 10,845,497, issued Nov. 24, 2020, entitled PHASE-SYNCHRONIZED BURIED OBJECT TRANSMITTER AND LOCATOR METHODS AND APPARATUS; U.S. Pat. 10,859,727, issued Dec. 8, 2020, entitled ELECTRONIC MARKER DEVICES AND SYSTEMS; U.S. Pat. 10,908,311, issued Feb. 2, 2021, entitled SELF-STANDING MULTI-LEG ATTACHMENT DEVICES FOR USE WITH UTILITY LOCATORS; U.S. Pat. 10,928,538, issued Feb. 23, 2021, entitled KEYED CURRENT SIGNAL LOCATING SYSTEMS AND METHODS; U.S. Pat. 10,935,686, issued Mar. 2, 2021, entitled UTILITY LOCATING SYSTEM WITH MOBILE BASE STATION; U.S. Pat. 10,955,583, issued Mar. 23, 2021, entitled BORING INSPECTION SYSTEMS AND METHODS; U.S. Pat. 10,983,240, issued Apr. 20, 2021, entitled MAGNETIC UTILTIY LOCATOR DEVICES AND METHODS; U.S. Pat. 10,983,239, issued Apr. 20, 2021, entitled MULTI-FREQUENCY LOCATING SYSTEMS AND METHODS; U.S. Pat.10,989,830, issued Apr. 27, 2021, entitled UTILITY LOCATOR APPARATUS AND SYSTEMS; U.S. Pat.11,014,734, issued May 25, 2021, entitled MARKING PAINT APPLICATOR APPARATUS; U.S. Pat. 11,029,439, issued Jun. 8, 2021, entitled UTILITY LOCATOR APPARATUS, SYSTEMS, AND METHODS; U.S. Pat. Application 63/212,713, filed Jun. 20, 2021, entitled DAYLIGHT VISIBLE AND MULTI-SPECTRAL LASER RANGEFINDERS AND ASSOCIATED METHODS AND UTILTIY LOCATOR DEVICES; U.S. Pat. 11,073,632, issued Jul. 27, 2021, entitled LOCATING DEVICES, SYSTEMS, AND METHODS USING FREQUENCY SUITES FOR UTILITY DETECTION; U.S. Pat. 11,092,712, issued Aug. 17, 2021, entitled UTILITY LOCATING SYSTEMS, DEVICES, AND METHODS; U.S. Pat.17/461,833, filed Aug. 30, 2021, entitled COMBINED SATELLITE NAVIGATION AND RADIO TRANSCEIVER ANTENNA DEVICES; U.S. Pat. 11,119,238, issued Sep. 14, 2021, entitled SATELLITE AND MAGNETIC FIELD SONDE APPARATUS AND METHODS; U.S. Provisional Pat. 63/248,995, filed Sep. 27, 2021, entitled SYSTEMS AND METHODS FOR DETERMINING AND DISTINGUISHING BURIED OBJECTS USING ARTIFICIAL INTELLIGENCE; U.S. Pat.11,137,513, issued Oct. 5, 2021, entitled INDUCTIVE CLAMP DEVICES, SYSTEMS, AND METHODS; U.S. Pat. Application 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. Pat. 11,156,737, issued Oct. 26, 2021, entitled BURIES OBJECT LOCATOR APPARATUS AND METHODS; and U.S. Pat. 11,175,427, issued Nov. 16, 2021, entitled BURIED UTILITY LOCATING SYSTEMS WITH OPTIMIZED WIRELESS DATA COMMUNICATION; U.S. Pat. Application 17/531,533, filed Nov. 19, 2021, entitled INPUT MULTIPLEXED SIGNAL PROCESSING APPARATUS AND METHODS; U.S. Pat. Application 17/540,239, filed Dec. 1, 2021, entitled DUAL SENSED LOCATING SYSTEMS AND METHODS; U.S. Pat.Application 17/541,057, filed Dec. 2, 2021, entitled COLOR-INDEPENDENT MARKER DEVICE APPARATUS, SYSTEMS, AND METHODS; U.S. Pat. Application 17/540,231, filed Dec. 2, 2021, entitled AUTO-TUNING CIRCUIT APPARATUS AND METHODS; U.S. Pat. 11,193,767, issued DECEMBER 7, 2021, entitled SMART PAINT STICK DEVICES AND METHODS; U.S. Pat. 11,199,521, issued Dec. 14, 2021, entitled RESILIENTLY DEFORMABLE MAGNETIC FIELD CORE APPARATUS AND APPLICATIONS; U.S. Pat. 11,204,246, issued Dec. 21, 2021, entitled DUAL SENSED LOCATING SYSTEMS AND METHODS; U.S. Provisional Pat. Application 63/293,828, filed Dec. 26, 2021, entitled MODULAR BATTERY SYSTEMS INCLUDING BATTERY INTERFACE APPARATUS; U.S. Pat. Application 17/563,049, filed Dec. 28, 2021, entitled SONDE DEVICES WITH A SECTIONAL FERRITE CORE; U.S. Provisional Pat. Application 63/306,088, filed Feb. 2, 2022, entitled UTILITY LOCATING SYSTEMS AND METHODS WITH FILTER TUNING FOR POWER GRID FLUCTUATIONS; U.S. Pat. Application 17/687,538, filed Mar. 4, 2022, entitled ANTENNAS, MULTI-ANTENNA APPARATUS, AND ANTENNA HOUSINGS; U.S. Pat Application 17/694,640, filed Mar. 14, 2022, entitled UTILITY LOCATORS WITH RETRACTABLE SUPPORT STRUCTURES AND APPLICATIONS THEREOF; U.S. Pat. Application 17/694,656, filed Mar. 14, 2022, entitled ELECTROMAGNETIC MARKER DEVICES FOR BURIED OR HIDDEN USE; U.S. Pat.11,280,934, issued Mar. 22, 2022, entitled ELECTROMAGNETIC MARKER DEVICES FOR BURIED OR HIDDEN USE; U.S. Pat. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. Pat. 11,300,700, issued Apr. 12, 2022, entitled SYSTEMS AND METHODS OF USING A SONDE DEVICE WITH A SECTIONAL FERRITE CORE STRUCTURE; U.S. Pat. 11,300,701, issued Apr. 12, 2022, entitled UTILITY LOCATORS WITH RETRACTABLE SUPPORT STRUCTURES; U.S. Pat.Application 17/728,949, filed Apr. 25, 2022, entitled BURIED UTILITY LOCATOR GROUND TRACKING APPARATUS, SYSTEMS, AND METHODS; U.S. Pat. Application 17/731,579, filed Apr. 28, 2022, entitled BURIED UTILITY MARKER DEVICES, SYSTEMS, AND METHODS; U.S. Pat. 11,333,786, issued May 17, 2022, entitled BURIED UTILITY MARKER DEVICES, SYSTEMS, AND METHODS; U.S. Pat. Application 17/833,799, filed Jun. 6, 2022, entitled TRACKED DISTANCE MEASURING DEVICES, SYSTEMS, AND METHODS; U.S. Pat. Application 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; U.S. Pat. 11,366,245, issued Jun. 21, 2022, entitled BURIED UTILITY LOCATOR GROUND TRCKING APPARATUS, SYSTEMS, AND METHODS; U.S. Pat. 11,397,274, issued Jul. 26, 2022, entitled TRACKED DISTANCE MEASURING DEVICES, SYSTEMS, AND METHODS; U.S. Pat. 11,428,814, issued Aug. 30, 2022, entitled OPTICAL GROUND TRACKING APPARATUS, SYSTEMS, AND METHODS FOR USE WITH BURIED UTILITY LOCATORS; U.S. Pat. Application 17/930,029, filedSep. 6, 2022, entitled GNSS POSITIONING METHODS AND DEVICES USING PPP-RTK, RTK, SSR, OR LIKE CORRECTION DATA; U.S. Pat.11,448,600, issued Sep. 20, 2022, entitled MULTI-CAMERA PIPE INSPECTION APPARATUS, SYSTEMS AND METHODS; U.S. Pat. Application 17/935,564, filed Sep. 26, 2022, entitled SYSTEMS AND METHODS FOR DETERMINING AND DISTINGUISHING BURIED OBJECTS USING ARTIFICIAL INTELLIGENCE; U.S. Pat. 11,460,598, issued Oct. 4, 2022, entitled USER INTERFACES FOR UTILITY LOCATORS; U.S. Pat. 11,467,317, issued Oct. 11, 2022, entitled ELCETROMAGNETIC MARKER DEVICES WITH SEPARATE RECEIVE AND TRANSMIT ANTENNA ELEMENTS; U.S. Pat. 11,468,610, issued Oct. 11, 2022, entitled METHODS AND SYSTEMS FOR GENERATING INTERACTIVE MAPPING DISPLAYS IN CONJUNCTION WITH USER INTERFACE DEVICES; U.S. Pat. 11,474,275, issued Oct. 18, 2022, entitled OMNI-INDUCER TRANSMITTING DEVICES AND METHODS; U.S. Pat. 11,474,276, issued Oct. 18, 2022, entitled SYSTEMS AND METHODS FOR UTILITY LOCATING IN A MULTI-UTILITY ENVIRONMENT; U.S. Pat. 11,476,539, issued Oct. 18, 2022, entitled MODULAR BATTERY PACK APPARATUS, SYSTEMS, AND METHODS INCLUDING VIRAL DATA AND/OR CODE TRANSFER; U.S. Provisional Pat. Application 63/380,375, filed Oct. 20, 2022, entitled LINKED CABLE-HANDLING AND CABLE-STORAGE DRUM DEVICES AND SYSTEMS FOR THE COORDINATED MOVEMENT OF A PUSH-CABLE; and U.S. Pat. 11,528,401, issued Dec. 13, 2022, entitled PIPE INSPECTION SYSTEMS WITH SELF-GROUNDING PORTABLE CAMERA CONTROLLERS; U.S. Pat. Application 18/089,266, filed Dec. 27, 2022, entitled MODULAR BATTERY SYSTEMS INCLUDING INTERCHANGEABLE BATTERY INTERFACE APPARATUS; U.S. Provisional Pat. Application 63/435,148, filed Dec. 23, 2022, entitled SYSTEMS, APPARATUS, AND METHODS FOR DOCUMENTING UTILITY POT-HOLES AND ASSOCIATED UTILITY LINES; U.S. Pat. 11,550,214, issued Jan. 10, 2023, SPRING ASSEMBLIES WITH VARIABLE FLEXIBILITY FOR USE WITH PUSH-CABLES AND PIPE INSPECTION SYSTEMS; U.S. Pat. 11,558,537, issued Jan. 17, 2023, entitled VIDEO INSPECTION SYSTEM WITH WIRELESS ENABLED CABLE STORAGE DRUM; and U.S. Pat. Application 11,561,317, issued Jan. 24, 2023, entitled GEOGRAPHIC MAP UPDATING METHODS AND SYSTEMS. The content of each of the above-described patents and applications is incorporated by reference herein in its entirety. The above applications may be collectively denoted herein as the “co-assigned applications” or “incorporated applications.”

### BRIEF DESCRIPTION OF THE DRAWINGS

FIG. 1 is an illustration of a system for detecting and locating buried objects associated with utilities or communication systems, as known in the prior art.

FIG. 2 is an illustration of an embodiment of a utility locator in accordance with certain aspects of the present invention.

FIG. 3 is an illustration of an embodiment of a method for detecting actual power grid frequencies using a calculated power grid frequency offset, in accordance with certain aspects of the present invention.

FIG. 4 is an illustration of an embodiment of a method for re-setting one or more filter detection bandwidth values, in accordance with certain aspects of the present invention.

FIG. 5 is an illustration of an embodiment of a method for detecting an actual power grid frequency using side bandpass filters configured with bandpass filter offsets, in accordance with certain aspects of the present invention.

FIG. 6 is an illustration of an embodiment of a method for detecting an actual power grid frequency using a power grid frequency offset calculated from a ratio of received electromagnetic (EM) amplitudes, in accordance with certain aspects of the present invention.

FIG. 7 is an illustration of an embodiment of a system for detecting an actual power grid frequency using a pair of side bandpass filters configured with their bandwidths overlapping, in accordance with certain aspects of the present invention.

FIG. 8 is an illustration of an embodiment of a system for determining a nominal power grid offset by determining the ratio of the received signal amplitudes of a pair of side bandpass filters.

FIG. 9 is an illustration of a diagram for tracking power grid frequencies using a locked loop.

FIG. 10 is an illustration of a frequency domain plot of a tracked power grid frequency.

FIG. 11 is an illustration of frequency domain plot using a low-pass filter to extract phase and frequency information from a single harmonic of a tracked power grid frequency.

FIG. 12 is an illustration of a frequency domain plot using an offset to approximate the actual harmonic frequency from a tracked power grid frequency.

FIG. 13 is an illustration of a diagram showing the complex components of a frequency offset with respect to time.

### DETAILED DESCRIPTION

In one aspect this disclosure relates to utility locating systems and methods. More specifically, but not exclusively, this disclosure relates to systems and methods for improving the quality and accuracy of utility locating systems by compensating for any utility power grid frequency fluctuations.

In some embodiments, a system for locating buried utility objects may include a utility locator including electronic circuity configured for detecting multifrequency electromagnetic data associated with the nominal (typical or expected) operating frequency in a specific location (country, region, state, street, or other area). Typical nominal power grid frequencies may be 50 Hz or 60 Hz, but other possible frequencies may exist. The system may include a detector module with electronics for detecting the actual power grid frequency at the location of the nominal operating frequency. The locating system may further include at least one processor and associated memory configured to determine if the actual power grid frequency is the same or different that the nominal power grid frequency.

In some embodiments, if the actual power grid frequency is determined to be different than the nominal grid frequency, a power grid frequency offset value may be determined. The power grid frequency offset may then be used to tune one or more filters. Once tuned, the filters may more quickly and accurately locate additional actual power grid frequencies, and/or harmonics of those power grid frequencies.

In some embodiments, bandpass filters, and/or side bandpass filters may be used to locate one or more power grid frequencies. However, it is also contemplated that other types of filters, e.g. Chebyshev filters, Butterworth filters, etc., could also be configured to locate the power grid frequencies.

Many types of filters could be used to locate the power grid frequencies, and are well known in the art. For instance, bandpass filters, side bandpass filters, Chebyshev filters, and the like.

In some embodiments, the nominal power grid frequency is precisely and dynamically detected. An offset between the nominal power grid frequency, and the actual detected power grid frequency is calculated, and the offset is then extrapolated forward into higher harmonics, and used to accurately configure or set those filters. Extrapolation in this sense means that the offset found at the nominal power grid frequency is multiplied by N, wherein N represents the Nth harmonic. As an example, for the 3d harmonic, N = 3, for the 5th N = 5, for the 200th, N = 200, etc. The base frequency, or 1st harmonic, is known as the fundamental harmonic. Therefore, any order harmonic N, of the fundamental harmonic, may be defined as Nth harmonic = fundamental harmonic x N.

In some embodiments, extrapolation may be used in a reverse direction to start with a harmonic of a fundamental frequency, and then find the actual frequency that was originally the actual frequency of the 10th harmonic may be detected at 610 Hz, and then by extrapolating back to the fundamental frequency you may determine that the 60 Hz you were detected was actually 61 Hz.

In some embodiments, extrapolation in both directions may be used, i.e. in both the forward and reverse directions. As an example, knowing the actual value of a specific harmonic backward extrapolation may be used to find the actual fundamental frequency, and then forward extrapolation of the actual fundamental frequency could be used to determine actual higher harmonic frequencies. As an example, knowing that the 10th harmonic is 610 Hz instead of 600 Hz reverse extrapolation could be used to determine that the fundamental frequency is 61 Hz. Then, forward extrapolation may be used to find a higher harmonic, for instance the 100th harmonic.

In some embodiments, the Nth harmonic may be determined by the harmonic frequencies of the nominal power grid frequency known to be easily detectable because they contain sufficient electromagnetic energy (their signal amplitude) based on their location. For instance, in San Diego, California, the frequency bands known to have the most energy are 60 Hz, 540 Hz (the 9th harmonic), and 900 Hz (the 15th harmonic).

In some embodiments, the Nth harmonic may be based on cases where N is an integer, i.e. a whole number, or since a utility system power grid is typically a non-linear system, N may be a fraction representing a fractional harmonic.

In some embodiments, if an offset found at a nominal power grid frequency cannot be determined at a high enough accuracy to allow a second filter configured to detect a higher harmonic frequency using the extrapolated offset, i.e. the second filter cannot detect the actual frequency at the higher harmonic, the offset determined at the nominal power grid frequency may then be used as a first estimate, to get closer or hone in on the actual higher harmonic frequency target by iteratively configuring the filters with slightly wider bandwidths until the desired frequencies can be detected. For instance, instead of a 2 Hz bandwidth filter, a 10 Hz wide filter could be used. Other approaches could use other filtering techniques such as using a broadband DFT (Discrete Fourier Transform), filtering using Nyquist sampling, and/or using several different filters or filtering methods/techniques running in parallel.

In some embodiments, in addition to monitoring one or more nominal power grid frequencies, phase measurements may also be taken. The more measurements that can be made, i.e. the number of harmonic measurements (magnitude and/or phase), the more accurate the results will be.

In some embodiments, a bank of filters frequency locked to a measured signal, e.g. the actual utility power grid frequency, may be used. As the grid fundamental frequency fluctuates, e.g. 50 Hz wanders down to 49.8 Hz, or 60 Hz wanders up to 60.3 Hz, as long as one or more filters are still tracking the signal, i.e. the frequency of the signal is still within the bandwidth of the filter, an estimate of the signal strength at the output of the tracking filters may be determined. Amplitude estimates at a number of different harmonics (k harmonics) may then be performed. The amplitude estimate values may then be dropped into a number of vector slots with k elements (also known as a k-vector), e.g. E.g., just like a 2d, 3d, or 4th vector in a plane, in space, or in Einstein’s space time. That k-vector is a signature of a specific utility. The vector may be normalized to a unit length or scaled such that one of its particular elements is 1. In some locations, every utility is going to have many, most, or even all of the same grid harmonics, and a locating system would have a better chance of telling the utilities apart by looking at a utility’s harmonic pattern, or structure. The vector of amplitudes is one way to characterize the harmonic structure.

In some embodiments, knowing which harmonics are available, i.e. which harmonics have signals with sufficient energy to be detected, can be determined by taking the spectrum of spectral components. This may be accomplished using a bandpass filter, and Cepstral analysis. Any desired harmonics may be analyzed. For instance, even harmonics, odd harmonics, odd harmonics excluding fundamental component, triplen harmonics, non-triplen odd harmonics, and non-triplen odd harmonics excluding fundamental component.

In some embodiments, one or more bandpass filters may be configured to detect a nominal power grid frequency by setting or tuning the center frequency (f₀) of one or more of the filters to the desired nominal frequency to be detected, and also determining the detection bandwidth of one or more of the filters by tuning the low cutoff frequency (f_{L}) and the high cutoff frequency (f_{H}) to the desired frequency detection range. As an example, if the nominal power grid frequency is 60 Hz, and it is desired to detect for fluctuations of the nominal frequency of +/- 5 Hz, a filter would be configured (tuned) with f₀ = 60 Hz, f_{L} = 55 Hz, and f_{H} = 65 Hz.

In some embodiments, it may be desired to detect smaller/finer variations in frequency fluctuations by tuning one or more bandpass filters with a narrower detection range or bandwidth. For instance, the filter could be configured to detect fluctuations of the nominal frequency of +/- 1 Hz, or +/- 0.5 Hz, etc. It would be understood by those skilled in the art that other values could be chosen as well.

In some embodiments, a pair of side bandpass filters may be used to more accurately detect the actual power grid frequency by adaptively adjusting the pair of side bandpass filters by using the power grid frequency offset. For instance, by adaptively moving the f₀ of a low side bandpass filter an offset value below the actual frequency, and moving the f₀ of a high side bandpass filter a substantially equal offset value above the actual frequency. In this sense adaptively refers to the iterative process of tuning the pair of filters with a determined offset value, using those filters to find a new offset value, and then using the new offset values to re-tune the pair of side band pass filters to again detect a new offset. This process may continue as desired. In some embodiments, the low side bandpass filter offset and high side bandpass filter offset values chosen may be different from each other, i.e. not substantially equal.

In some embodiments, monitoring the nominal power grid frequency may include detecting an electromagnetic frequency using a receiver including one or more preset filters. The one or more preset filters may have the same or different values.

In some embodiments, if the calculated power grid frequency offset is undetermined, then a Nth harmonic can be detected by configuring one or more bandpass filters by setting the center frequency of a bandpass filter to (f₀) = Nth harmonic frequency, the low cutoff frequency (f_{L}) = f₀ - N x k, and the high cutoff frequency (f_{H}) = f₀ + N x k, where f₀ is the center frequency of a bandpass filter, N is the Nth harmonic frequency, and the value of k is based on an educated guess of the amount a nominal frequency is expected to fluctuate from an actual frequency at a certain harmonic. Values of k could be determined based on a historical record of power grid offsets known to exist for specific utilities in a specific location.

In some embodiments, the Nth harmonic frequency used may simply be a multiple of the nominal frequency, e.g. if the nominal power grid frequency is 60 Hz, then the 3d harmonic would have N = 3, and f₀ could be set to 60 × 3 = 180 Hz. The Nth harmonic could also be based on the actual power grid frequency, or any other desired frequency.

In some embodiments, an estimated error (E) of the nominal power grid frequency f₀ may be defined as f₀ + E. Then a naive estimate of where to tune the Nth harmonic filter is N x (f₀ + E) = (N x f₀) + (N x E). If the bandwidths of the low and high filters are wide, then we can ignore the estimation error and always put the low and high band filters at the same place. Otherwise, the same error, N x E, applies to each f_{L} and f_{H} of the filters.

In some embodiments, we may use one or more filters to track the power grid nominal frequency by setting the filters to track multiple frequencies representing different harmonics of the nominal frequency. Given a number of filters, the list of naive filter frequencies is {f₁, f₂, f₃, ...f_{N}} where f_{N} = N x f₁, where N is the highest harmonic number, and f₁ is the base frequency of the harmonic frequencies. As previously mentioned, f₁ may be chosen to be nominal power grid frequency, the actual power grid frequency, or an other desired value.

After all of the filters have independently tracked for a while (e.g. a specific time period), it will no longer be true that the estimated frequencies in each case are integer multiples of f₁. We can then call list of tracked frequencies {f′₁, f′₂, f′₃,... f′_{N}}. Then we can determine a good estimate of the actual grid frequency as the ordinary least squares (OLS) fit to the set {f′₁, f′₂, f′₃,... f′_{N}} evaluated at N=1.

In some embodiments, we could initially track a set of triplen harmonics (the odd multiples of the third harmonic) of a given nominal frequency. As an example, starting with a nominal frequency of 60 Hz, we could track the first, third, and 7th multiple of the third harmonic by setting one or more filters with f₀ = 180 Hz, 540 Hz, and 1,260 Hz. Other triplen values, as well as the individual number of values could be chosen.

In some embodiments, tuning one or more filters based on the calculated power grid frequency offset may include adjusting the digital clock controlling the filters, adjusting the filters using an FPGA field programmable gate array.

In some embodiments, a nominal power grid frequency may be monitored using a low side bandpass filter and a high side bandpass filter configured with a portion of their bandwidths overlapping. The ratio of received electromagnetic (EM) amplitude between the two filters may then be determined by dividing the value of the amplitude detected by the low side bandpass filter by the value of the amplitude detected by the high side bandpass filter. A power grid frequency offset could then be determined using the ratio, and then the actual power grid frequency could be calculated based on the offset.

In some embodiments, a nominal power grid frequency may be monitored to detect a phase change per unit of time as compared to an adjustable local oscillator (LO) to determine any frequency (f) and phase differences between the local oscillator and the actual grid frequency. By determining the change between the LO and the grid phase (Δϕ), for a given change in time (Δt), we can find the frequency offset directly using f offset = Aϕ / Δt in cycles per second. Then the f offset can be applied to the adjustable LO until the f offset = zero, i.e. by using an FLL (frequency-locked loop). Alternatively, the absolute difference in phase between the actual grid frequency and local oscillator can be driven to zero, i.e. by using a PLL (phase-locked loop). By keeping track of the phase errors, and iteratively providing feedback to the adjustable LO, we are providing both FLL/PLL functionality.

In some embodiments, a single FLL/PLL may be tuned to track a single harmonic of a selected fundamental frequency. Then, by extrapolating values from the single tracked harmonic, the true (actual) value of all other harmonics of the original desired frequency may be determined.

In other embodiments, multiple FLL/PLL may be used by individually tuning a different FLL/PLL to each harmonic of interest selected to be tracked. Tuning of each filter may be accomplished by providing feedback to an adjustable LO.

In some embodiments as previously described, although reference has been made specifically to a nominal power grid frequency or an actual power grid frequency, it is contemplated that a harmonic of the nominal power grid frequency or a harmonic of the actual power grid frequency may be used.

In some embodiments, the FLL/PLL tracking frequency of the LO can be used to tune the center frequency of a filter used for detecting the actual power grid frequency.

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### EXAMPLE EMBODIMENTS

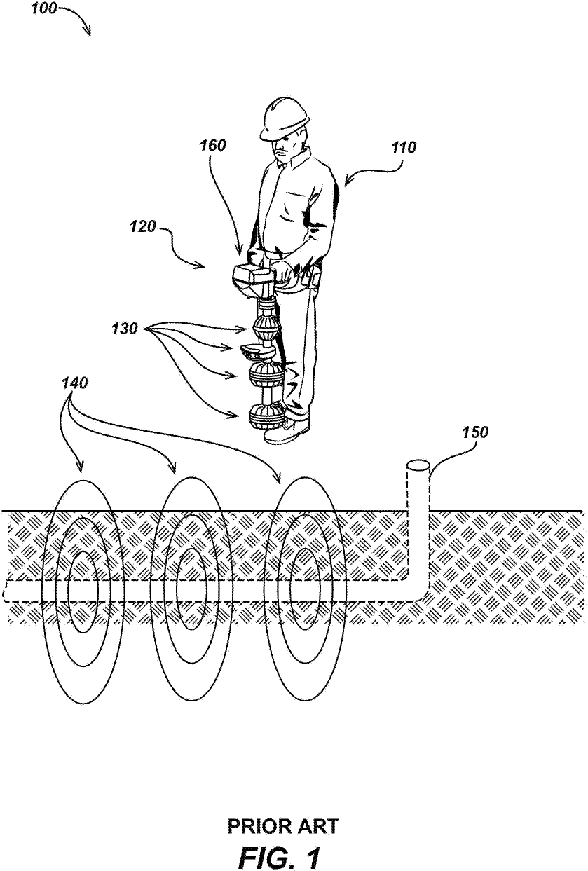

FIG. 1 (Prior Art) is an example of a typical utility locating system 100 for detecting electromagnetic signals from buried and/or underground objects associated with utilities. As shown, a service worker 110 may use a portable utility locator 120 configured with receiving circuitry and other electronics, including a processor (not shown), and one or more antennas 130, to detect various electromagnetic signals 140 emitted from buried or otherwise inaccessible pipes and other conduits 150, as well as electrical cables, and/or inserted transmitters (not shown). A user interface 160 may be provided to allow the selection of specific locating functions.

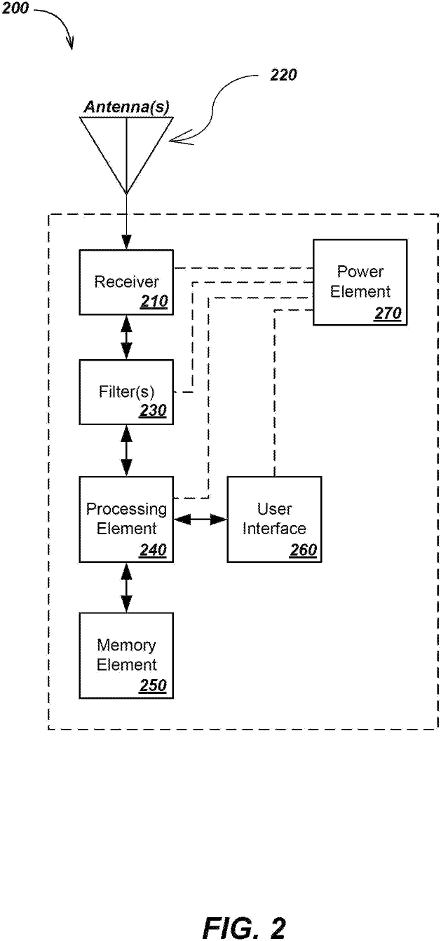

FIG. 2 illustrates details of an exemplary embodiment of the components of a utility locator 200. The utility locator 200 may include a receiver 210 configured with one or more antennas 220 for receiving electromagnetic signals emitted from buried and/or underground utility objects. Signals received may also include above ground electromagnetic signals. One or more filters 230 may be used to detect specific desired signals, while at the same time ignoring other undesired signals, e.g. signals with undesired frequencies, noise, etc. Utility locator 200 may include a processing element 240 with corresponding memory 250, and a user interface 260. A power element 270 is configured to provide power as required by the electrical components. Although not shown, many other components may be included to provide additional functionality to the utility locator 200. Other typical components may include various sensors, controls, displays, interface ports and/or connectors, and the like.

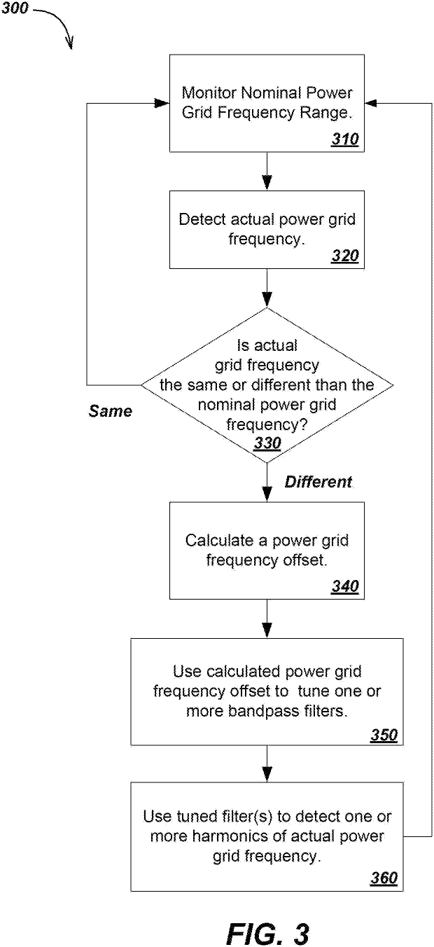

FIG. 3 illustrates details of an exemplary embodiment 300 of a method for detecting actual power grid frequencies using a calculated power grid frequency offset. The method starts by monitoring the nominal power grid frequency range for a specific utility 310, and then detecting the actual utility power grid frequency 320. In decision step 330, a comparison is made to determine if the actual power grid frequency is the same, or different, than the nominal power grid frequency. If the two compared frequencies are the same, the method starts over by once again monitoring the nominal power grid frequency 310. If, however, the two compared frequencies are different, the method proceeds to step 340 where a power grid frequency offset (the difference between the nominal power grid frequency and the actual power grid frequency) is calculated. Next, the calculated power grid frequency offset is used to tune one or more bandpass filters 350. The one or more tuned filters are then used to detect one or more harmonics of the actual power grid frequency 360. The method iteratively repeats, as long as desired, to monitor one or more nominal power grid frequencies 310, using one or more tuned filters to detect one or more harmonics of the actual grid frequency 360.

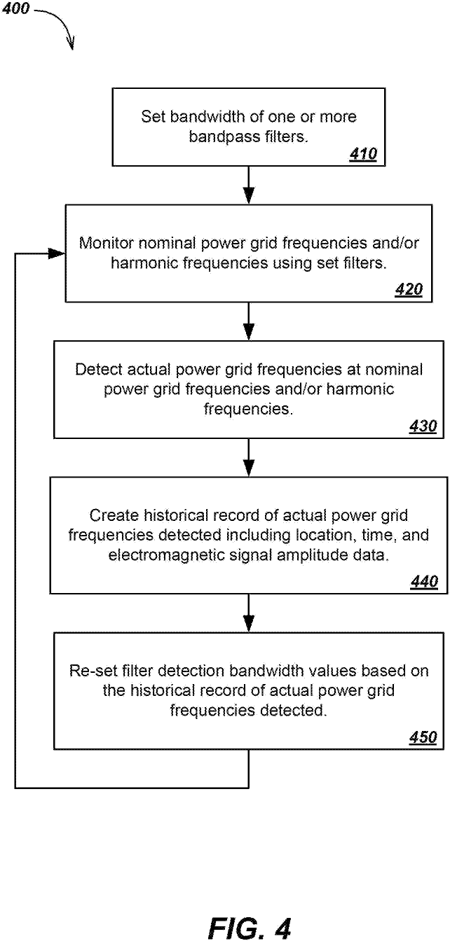

FIG. 4 illustrates details of an exemplary embodiment 400 of a method for re-setting one or more filter detection bandwidth values. The method starts at step 410 by setting the bandwidth of one or more bandpass filters. Next, one or more nominal power grid frequencies, and/or one or more corresponding harmonic frequencies are monitored using one or more filters set or tuned to detect those frequencies 420. At step 430, the actual power grid frequencies, and/or corresponding harmonic frequencies are detected. Next, a historical record of actual power grid frequencies detected is created, which may include data such as location, time, electromagnetic signal amplitude data, and other detection related data 440. Next, at step 450 the bands of the one or more filters set at step/step 410 is re-set based on the historical record of actual power grid frequencies detected at step 440. The method iteratively repeats, as long as desired, to monitor one or more nominal power grid frequencies, and/or one or more corresponding harmonic frequencies 420 with the re-set filter values.

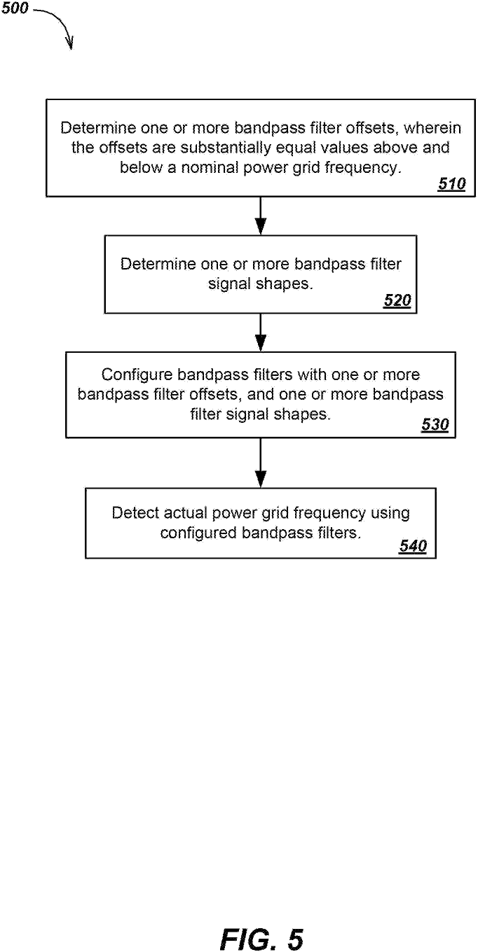

FIG. 5 illustrates details of an exemplary embodiment 500 of a method for detecting an actual power grid frequency using side bandpass filters configured with bandpass filter offsets. The method begins at step 510 by determining one or more bandpass filter offsets, wherein the offsets are substantially equal values above and below a nominal power grid frequency. Next, one or more bandpass filter signal shapes are determined 520, and used to configure one or more bandpass filters with one or more bandpass filter offsets, and one or more bandpass filter signal shapes 530. Lastly, at step 540, the actual power grid frequency is detected using the one or more configured bandpass filters.

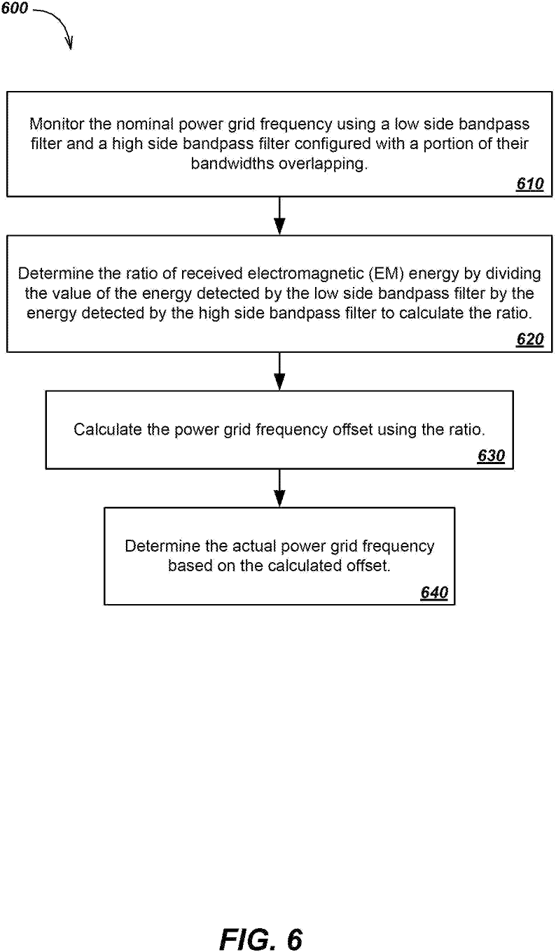

FIG. 6 illustrates details of an exemplary embodiment 600 of a method for detecting an actual power grid frequency using a power grid frequency offset calculated from a ratio of the received electromagnetic (EM) amplitudes. The method starts at step 610 by monitoring the the nominal power grid frequency using a low side bandpass filter and a high side bandpass filter configured with a portion of their bandwidths overlapping. Next, the ratio of received electromagnetic (EM) energy (the signal amplitude) is determined by dividing the value of the energy detected by the low side bandpass filter by the energy detected by the high side bandpass filter to calculate the ratio of received (EM) energy between the two filters 620. At step 630, the power grid frequency offset is calculated using the determined ratio. Finally, the actual power grid frequency is determined based on the calculated offset 640.

The aforementioned method steps described in various embodiments above are intended only to describe the basic methods, however, it is contemplated that other additional steps could be included that would not alter either the spirit of, or the actual method as described. These additional steps would be readily apparent to those of ordinary skill in the art.

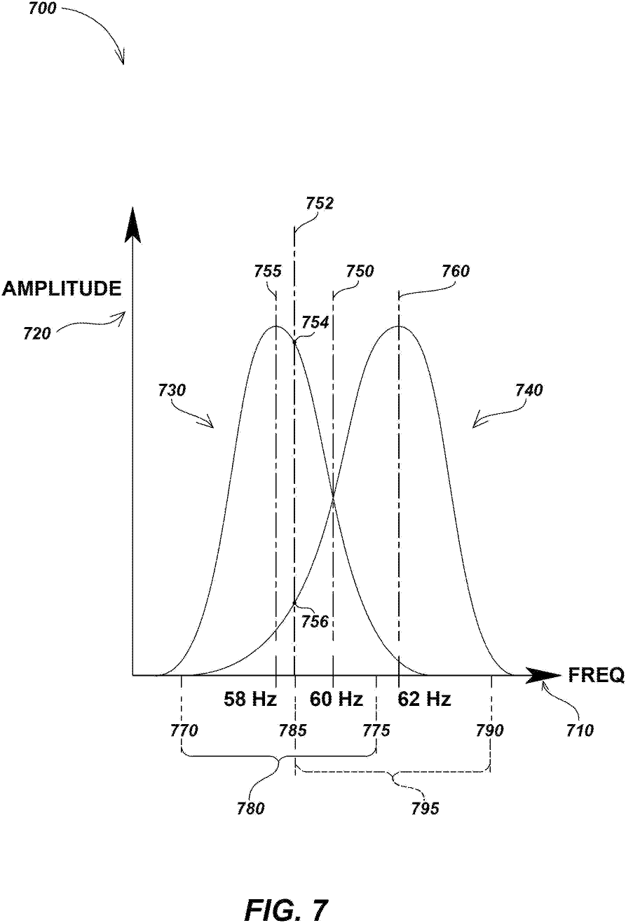

FIG. 7 illustrates details of an exemplary embodiment 700 a system for detecting an actual power grid frequency using a pair of side bandpass filters 730 and 740 configured with their respective bandwidths 780 and 795 overlapping. In this example, the waveforms of a low side bandpass filter 730, aka Filter A, and a high side bandpass filter 740, aka Filter B, are plotted on a graph where the frequency-axis 710 is represented by the x-axis, and the amplitude of a detected signal 720 is represented by the y-axis. Both Filter A 730 and Filter B 740 are shown to overlap a nominal power grid frequency of 60 Hz 750. Filters A and B 730, 740, have their center frequencies (f₀), set or tuned to 58 Hz 755, and 62 Hz 760, respectively. Filter A has a detection bandwidth 780 defined by low cutoff frequency (f_{L}) 770 and high cutoff frequency (f_{H}) 775, and Filter B has a detection bandwidth 795 defined by defined by low cutoff frequency (f_{L}) 785 and high cutoff frequency (f_{H}) 790. It should be noted that all values given, including the filter bandwidth values and signal shapes, are exemplary only.

In this example the actual power grid frequency 752 detected by both filters is shown to be 59 Hz. This frequency intersects with Filter A waveform 730 at point 754, and intersects with Filter B waveform 740 at 756. It can be seen that the amplitude of the signal detected by Filter A at point 754, is higher than the signal detected by Filter B at point 756. By determining the ratio of the amplitude of the signal received by Filter A 730 at point 754 to the amplitude of the signal received by Filter B 740 (Amplitude Filter A / Amplitude Filter B), an offset or error from the nominal power grid frequency may be used to accurately determine the actual power grid frequency. In this example, the offset value determined from the ratio would be 1 Hz, so 60 Hz nominal frequency - 1 Hz offset = 59 Hz actual power grid frequency. Since we divided Filter A amplitude by Filter B amplitude, a ratio of greater than 1 would represent a negative offset (actual frequency < nominal frequency), and a ratio of less than 1 would represent a positive offset (actual frequency > nominal frequency). If instead of taking the ratio as A:B, we took it as B:A, the direction of the offset based on a ratio of less than one, or greater than 1, would be reversed.

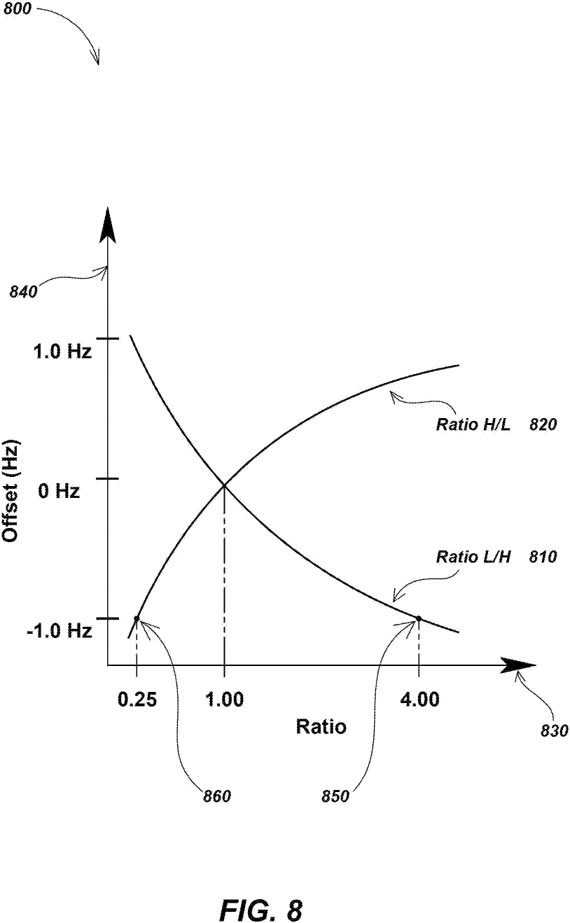

FIG. 8 illustrates details of an exemplary embodiment 800 of a system for determining a nominal power grid offset by determining the ratio of the received signal amplitudes of a pair of side bandpass filters. Curve 810 represents the plot of the ratio of a low side bandpass filter/a high side bandpass filter, and curve 820 represents the plot of the ratio of a high side bandpass filter/a low side band pass filter. Note: both of these filters, low side bandpass Filter A 730, and high side bandpass Filter B 740 are shown in FIG. 7. The curves are plotted on a graph with the determined offset ratio represented on the x-axis 830, and the offset frequency shown on the y-axis 840. In the example in FIG. 7, the nominal power grid frequency was 60 Hz, and the actual power grid frequency was 59 Hz. Given these values, the ratio of the signal amplitude received by Filter A 730 compared to Filter B 740 is shown to intersect curve 810 at point 850 which shows a ratio value of 4.0. This value would represent an offset of -1 Hz, so the actual frequency detected would be 60 Hz - 1 Hz = 59 Hz. If instead the ratio was taken by comparing the signal amplitude received by Filter B 740 compared to Filter A 730, the intersection point 860 of curve 820 would show a ratio of 0.25 which would also represent an offset of -1 Hz, resulting in an actual power grid frequency of 59 Hz.

In both examples, the signal amplitude detected by Filter A 730 was 4 times the signal amplitude detected by Filter B 740. The absolute value of both offsets was 1.0 Hz with the direction of the offset determined by whether the ratio was greater than 1 or less than 1, and which filter signal amplitude was used as the numerator, and which was used as the denominator when determining the ratio. A ratio of exactly 1.0 would represent an offset of zero meaning that the nominal power grid frequency and the actual power grid frequency were equal to each other.

Illustrates details of an exemplary embodiment 900 of a diagram for tracking power grid frequencies using a locked loop. A receiver 910 may be configured to receive grid spectrum frequencies 915, i.e. EMF signals from a utility power grid. The receiver 910 may include an analog to digital converter (ADC) 920. Sensed grid signals at node 930 from the receiver 910 are then input into a mixer or down-converter 940. Down-converted signals 945 are then input into a complex low-pass filter 950. From there, the magnitude and phase of the filtered signals from complex low-pass filter 950 may be used for utility locating. Note that the complex result of the filtered signal can be represented by I +jQ where the magnitude can be determined by (I² + Q²)^{½}, and the phase can be determined by arctan (Q/I). Complex low-pass filter 950 outputs filtered signal (F) 955 which may then be used to calculate the phase and/or frequency error in block 960, and the results of the calculations may scaled by the gain K of amplifier 970. Filtered signal (F) 955 may also be used for locating the utility. From amplifier 970 the signal is input into an adjustable quadrature local oscillator (LO) 980 which maybe be adjusted by a quantity output of amplifier 970 to more closely represent a harmonic of interest of a received power grid frequency from receiver 910. Output frequency 990 will then be fed back into mixer 940.

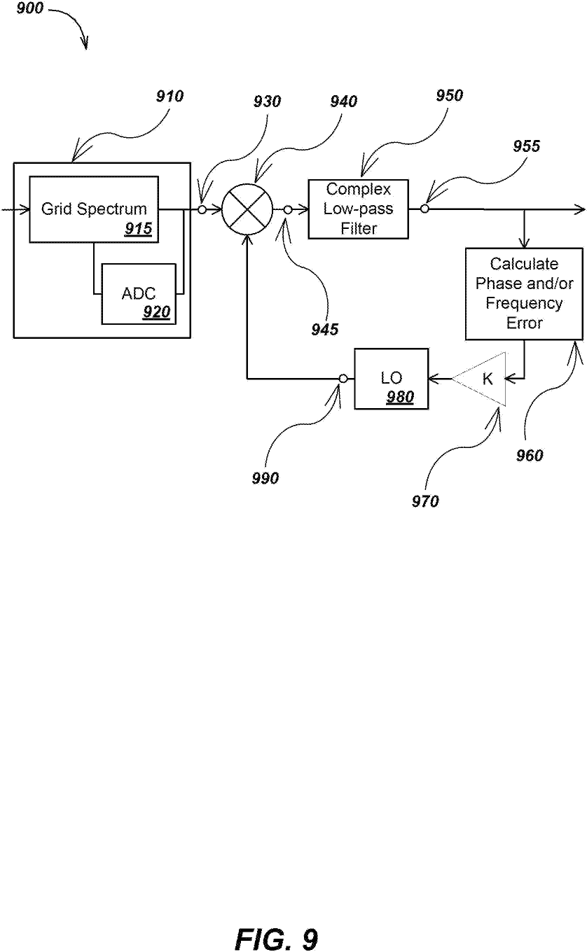

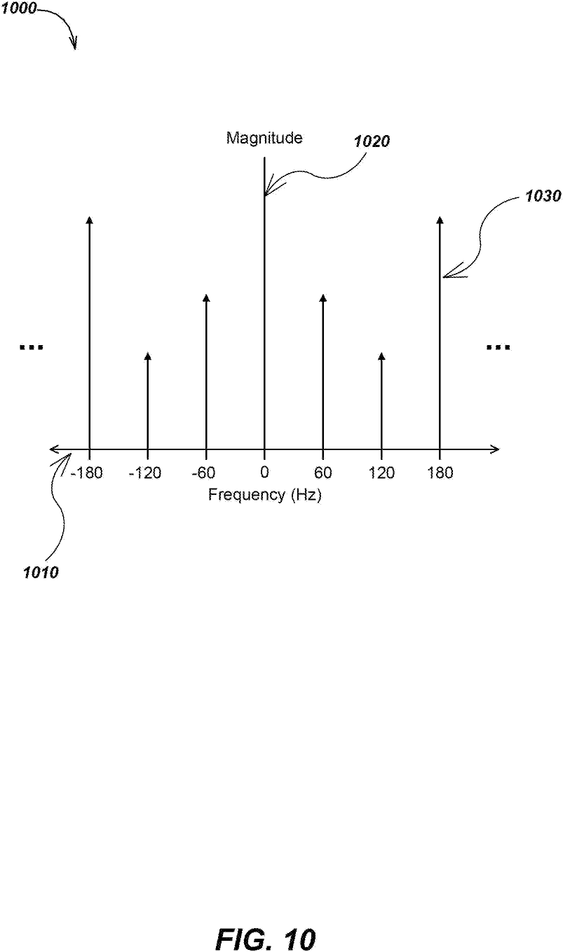

FIG. 10 illustrates details of an exemplary embodiment 1000 of a frequency domain plot of a tracked power grid spectrum. The x axis 1010 represents the monitored frequency in Hz of the power utility grid detected from receiver 910 (see FIG. 9) at node 930, and the y axis 1020 represents the magnitude of the signal strength taken throughout a finite duration of time. In this example, the harmonic of interest 1030 is 180 Hz.

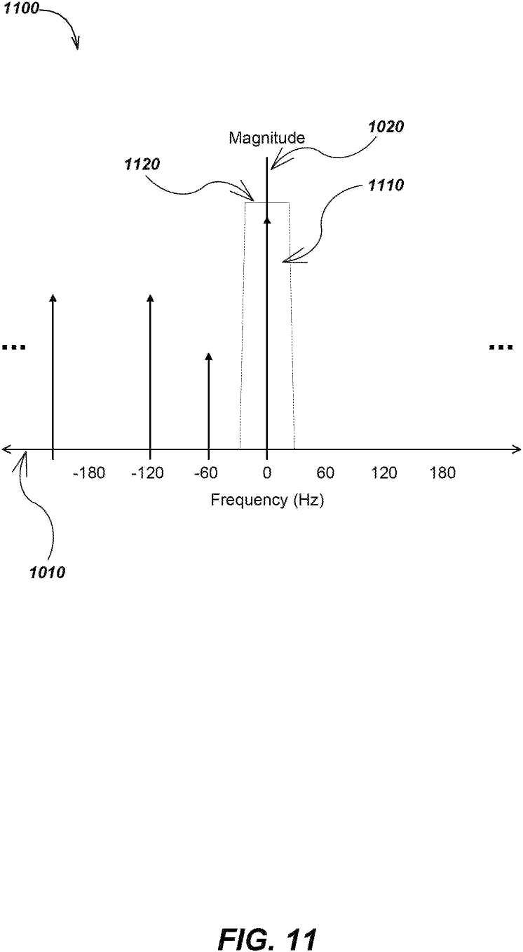

FIG. 11 illustrates details of an exemplary embodiment 1100 of a frequency domain spectrum plot using a filter to isolate and track a single harmonic of a power grid frequency. The x axis 1010 represents the monitored frequency in Hz of the power utility grid from receiver 910 (see FIG. 9). A harmonic signal of interest 1110 is shown after it has passed through mixer 940 at which point it has a very low frequency so that complex low-pass filter 950 with a magnitude response of 1120 can be used to extract in-phase (I) and quadrature (Q) components of a single harmonic, i.e. mixer 940 and complex low-pass filter 950 are acting as a bandpass filter.

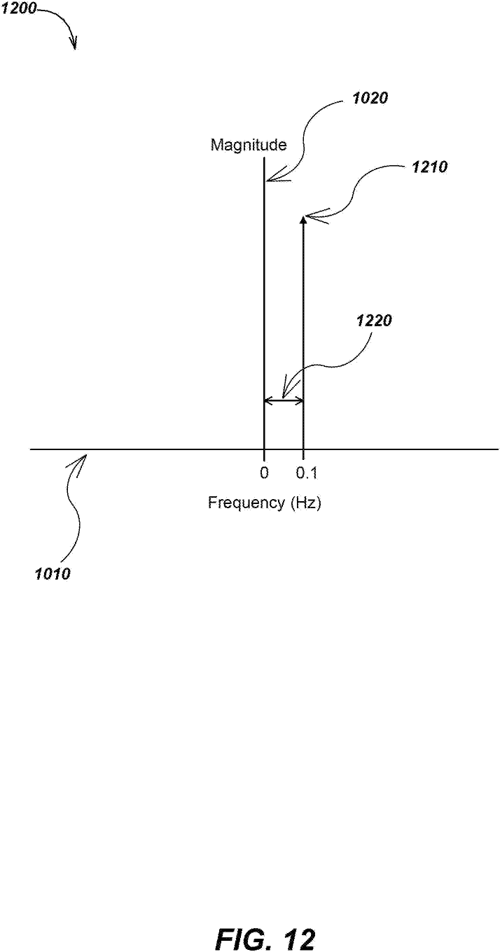

FIG. 12 illustrates details of an exemplary embodiment 1200 of a frequency domain plot using an offset to approximate the actual harmonic frequency from a tracked power grid frequency. This is a zoomed in view of the harmonic of interest after the complex low-pass filter 950 (See FIG. 9). The harmonic of interest 1210 is shown with an offset 1220 of 0.1 Hz after being down-converted in the mixer with the current best-guess of the actual harmonic frequency.

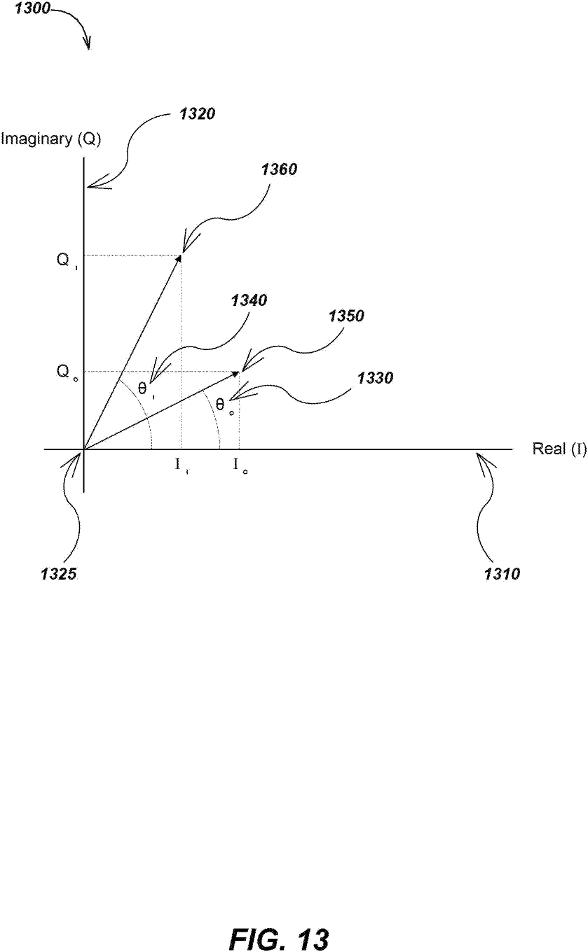

FIG. 13 is an illustration of a diagram 1300 showing the complex components of a phase change with respect to time. Diagram 1300 is shown with real axis 1310, imaginary axis 1320, and origin 1325. Filtered signal (F) 955 (FIG. 9) is shown at two instances in time: F₀ (F @ t₀) is shown as F₀ = I₀ + jQ₀, and F₁ (F @ t₁) is shown as F₁ = I₁ + jQ₁. The two phases are shown as phase at t₀ = Φ₀ 1330, and phase at t₁ = Φ₁ 1340. The diagram shows how change of phase with respect to time gives a direct measurement of frequency offset. It also shows an example of relative phase at two instances in time: Φ₀ and Φ₁. The magnitude at t₀ 1350, and the magnitude at t₁ 1360 can then be determined as follows:

$${\text{magnitude @ t}}_{0} {\text{1350: Mag @ t}}_{0} \text{=} {\left({\text{I}}_{\text{o}} {}^{2} {\text{+ Q}}_{\text{o}} {}^{2}\right)}^{1 / 2}$$

$${\text{magnitude @ t}}_{1} {\text{1360: Mag @ t}}_{1} \text{=} {\left({\text{I}}_{\text{1}} {}^{2} {\text{+ Q}}_{\text{1}} {}^{2}\right)}^{1 / 2}$$

The phases can be determined as follows:

$${\text{Φ}}_{0} = arctan \left({\text{Q}}_{0} / {\text{I}}_{0}\right)$$

$${\text{Φ}}_{1} = arctan \left({\text{Q}}_{1} / {\text{I}}_{1}\right)$$

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

We claim:

1. A system for locating buried utility objects, comprising:
a utility locator including:
an electronic circuit for detecting multifrequency electromagnetic data associated with a nominal power grid frequency;
a detector module for detecting an actual power grid frequency; and
at least one processor and associated memory programmed to determine if the actual power grid frequency is the same or different than the nominal power grid frequency.

2. The system of claim 1, wherein if the actual power grid frequency is different than the nominal power grid frequency, the at least one processor is further programmed to calculate a power grid frequency offset; and
tuning circuitry for tuning one or more filters based at least in part on the calculated power grid frequency offset.

3. The system of claim 1, wherein the nominal power grid frequency is 50 Hz or 60 Hz.

4. The system of claim 1, wherein the at least one processor is further programmed to use the power grid frequency offset to calculate a Nth harmonic offset, wherein the Nth harmonic offset equals the nominal power grid frequency offset times N.

5. The system of claim 2, wherein tuning the one or more filters based on the calculated power grid frequency offset comprises determining a center frequency (f₀) of one or more bandpass filters.

6. The system of claim 5, further comprising determining a low cutoff frequency (f_{L}) and a high cutoff frequency (f_{H}) for each of the one or more bandpass filters.

7. The system of claim 5, wherein the f₀ is set to the actual power grid frequency for at least one of the bandpass filters.

8. The system of claim 5, wherein the f₀ is set to a Nth harmonic of the actual power grid frequency for at least one of the bandpass filters.

9. The system of claim 5, wherein tuning the one or more filters based on the calculated power grid frequency offset comprises adaptively moving the f₀ of a low side bandpass filter an offset value below the actual frequency, and moving the f₀ of a high side bandpass filter a substantially equal offset value above the actual frequency.

10. The system of claim 5, wherein tuning the one or more filters based on the calculated power grid frequency offset comprises adaptively moving the f₀ of a low side bandpass filter an offset value below the nominal frequency or a harmonic of the nominal frequency, and moving the f₀ of a high side bandpass filter a substantially equal offset value above the nominal frequency or the harmonic of the nominal frequency.

11. The system of claim 8, wherein the Nth harmonic is determined by harmonic frequencies of the nominal frequency known to be easily detectable because they contain sufficient electromagnetic amplitude based on their location.

12. The system of claim 1, wherein detecting the actual power grid frequency comprises monitoring a plurality of harmonic frequencies of the nominal power grid frequency to detect a signal with sufficient amplitude to accurately calculate the actual power grid frequency.

13. A method for locating buried utility objects, comprising:
monitoring a nominal power grid frequency;
detecting an actual power grid frequency; and
determining if the actual power grid frequency is the same or different than the nominal power grid frequency.

14. The method of claim 13, wherein if the actual power grid frequency is different than the nominal power grid frequency, calculating a power grid frequency offset; and
tuning one or more filters based on the calculated power grid frequency offset.

15. The method of claim 13, wherein the nominal power grid frequency is 50 Hz or 60 Hz.

16. The method of claim 14, wherein the power grid frequency offset is used to calculate a Nth harmonic offset, wherein the Nth harmonic offset equals the nominal power grid frequency offset times N.

17. The method of claim 14, wherein tuning the one or more filters based on the calculated power grid frequency offset comprises determining a center frequency (f₀) of a bandpass filter.

18. The method of claim 17, further comprising determining a low cutoff frequency (f_{L}) and a high cutoff frequency (f_{H}) of the bandpass filter.

19. The method of claim 17, wherein the f₀ is set to the actual power grid frequency.

20. The method of claim 17, wherein the f₀ is set to a Nth harmonic of the actual power grid frequency.

21. The system of claim 17, wherein tuning the one or more filters based on the calculated power grid frequency offset comprises adaptively moving the f₀ of a low side bandpass filter an offset value below the actual frequency, and moving the f₀ of a high side bandpass filter a substantially equal offset value above the actual frequency.

22. The system of claim 17, wherein tuning the one or more filters based on the calculated power grid frequency offset comprises adaptively moving the f₀ of a low side bandpass filter an offset value below the nominal frequency or a harmonic of the nominal frequency, and moving the f₀ of a high side bandpass filter a substantially equal offset value above the nominal frequency or the harmonic of the nominal frequency.

23. The method of claim 20, wherein the Nth harmonic is determined by harmonic frequencies of the nominal frequency known to be easily detectable because they contain sufficient electromagnetic amplitude based on their location.

24. The method of claim 13, wherein detecting the actual power grid frequency comprises monitoring a plurality of harmonic frequencies of the nominal power grid frequency to detect a signal with sufficient amplitude to accurately calculate the actual power grid frequency.

25. The method of claim 14, wherein tuning the one or more filters based on the calculated power grid frequency offset comprises adjusting a digital clock controlling the one or more filters.

26. The method of claim 14, wherein tuning the one or more filters based on the calculated power grid frequency offset comprises adjusting the one or more filters using an FPGA (field programmable gate array).

27. The method of claim 14, wherein if the difference a between the actual power grid frequency and the nominal power grid frequency is within a preset tolerance, setting the power grid frequency offset to zero.

28. The method of claim 13, wherein monitoring the nominal power grid frequency comprises detecting an electromagnetic frequency using a receiver including one or more preset filters.

29. The method of claim 28, wherein at least two of the one or more preset filters have different preset values.

30. The method of claim 18, wherein if the calculated power grid frequency offset is undetermined, then a Nth harmonic can be detected by setting the center frequency (f₀) = Nth harmonic frequency, the low cutoff frequency (f_{L}) = f₀ - N x k, and the high cutoff frequency (f_{H}) = f₀ + N x k.

31. The method of claim 13, wherein monitoring the nominal power grid frequency comprises detecting an electromagnetic frequency by setting one or more filters to the nominal frequency using a phase-locked loop (PLL) to adjust a digital signal processor (DSP) time-base to be locked to the actual power grid frequency, and then using that time-base to tune one or more bandpass filters to track the actual power grid frequency.

32. A method for locating buried utility objects, comprising the steps of:
a) setting the bandwidth of one or more filters to monitor one or more nominal power grid frequencies and/or one or more harmonic frequencies thereof;
b) detecting one or more actual power grid frequencies at the one or more nominal power grid frequencies and/or harmonic frequencies;
c) creating a historical record of the actual power grid frequencies detected including data related to location, time, and electromagnetic signal amplitude;
d) re-setting the detection bandwidth values of the one or more filters based on the historical record of actual power grid frequencies detected; and
e) repeating steps b through d.

33. A method for locating buried utility objects, comprising:
determining one or more bandpass filter offsets, wherein the offsets are substantially equal values above and below a nominal power grid frequency;
determining one or more bandpass filter signal shapes;
configuring a plurality of bandpass filters with one or more bandpass filter offsets, and one or more band pass filter signal shapes; and
detecting an actual power grid frequency using the configured plurality of bandpass filters.

34. The method of claim 33, wherein the plurality of bandpass filters use at least one different bandpass filter offset.

35. The method of claim 33, wherein the plurality of bandpass filters use at least one different bandpass filter shape.

36. A method for locating buried utility objects, comprising:
monitoring a nominal power grid frequency using a low side bandpass filter and a high side bandpass filter configured with a portion of their bandwidths overlapping;
determining a ratio of received electromagnetic (EM) amplitude by dividing the value of the amplitude detected by the low side bandpass filter by the value of the amplitude detected by the high side bandpass filter to calculate the ratio;
calculating a power grid frequency offset using the ratio; and
determining the actual power grid frequency based on the calculated offset.

37. The method of claim 36, wherein if the ratio is 1, the nominal power grid frequency and the actual power grid frequency are substantially equal, if the ratio is greater than one, the actual power grid frequency is less than the nominal power grid frequency, and if the ratio is less than one, the actual power grid frequency is greater than the actual power grid frequency.

38. A method for locating buried utility objects, comprising:
monitoring a nominal power grid frequency using a low side bandpass filter and a high side bandpass filter configured with a portion of their bandwidths overlapping;
determining a ratio of received electromagnetic (EM) amplitude by dividing the value of the amplitude detected by the high side bandpass filter by the value of the amplitude detected by the low side bandpass filter to calculate the ratio;
calculating a power grid frequency offset using the ratio; and
determining the actual power grid frequency based on the calculated offset.

39. The method of claim 38, wherein if the ratio is 1, the nominal power grid frequency and the actual power grid frequency are substantially equal, if the ratio is greater than one, the actual power grid frequency is greater than the nominal power grid frequency, and if the ratio is less than one, the actual power grid frequency is less than the actual power grid frequency.

40. The method of claim 36 or 38, further comprising monitoring at least one harmonic of the nominal power grid frequency.

41. The method of claim 36 or 38, further comprising monitoring multiple harmonics of the nominal power grid frequency.

42. The method of claim 41, wherein the multiple harmonics comprise at least two harmonic frequencies chosen from the group consisting of triplen harmonics of the nominal power grid frequency.

43. The method of claim 36 or 38, further comprising monitoring a rate of change in the ratio with respect to time, and using the rate of change to determine at least one of a bandwidth adjustment, a spacing adjustment, and a shape adjustment, and applying the adjustment to one or more filters.

44. The system of claim 17, wherein tuning the one or more filters based on the calculated power grid frequency offset comprises adaptively moving the f₀ of a low side bandpass filter a first offset value below the nominal frequency or a harmonic of the nominal frequency, and moving the f₀ of a high side bandpass filter a second offset value above the nominal frequency or the harmonic of the nominal frequency, wherein the first offset value and the second offset value are different.

45. A method for locating buried utility objects, comprising:
monitoring a nominal power grid frequency;
detecting an actual power grid frequency;
determining a phase change per unit of time between an expected nominal grid frequency and a local oscillator;
calculating a frequency offset using the determined phase change per unit of time; and
adjusting a local oscillator using the determined frequency offset.

46. The method of claim 45, wherein monitoring the actual power grid frequency comprises tracking an electromagnetic frequency by setting one or more filters to the nominal frequency then using a phase-locked loop (PLL) to adjust a signal processing time-base to be locked to the actual power grid frequency, and then using that time-base to tune one or more filters to track the actual power grid frequency.

47. The method of claim 46, wherein the one or more filters are integral with a utility locator device.

48. A method for monitoring multiple harmonic frequencies, comprising;
tracking a selected harmonic frequency of a fundamental frequency using an FLL/PLL;
computing additional harmonic frequencies of the fundamental frequency using one or more processors configured to mathematically extrapolate the additional harmonic frequencies based on the selected harmonic frequency; and
adjusting a local oscillator (LO) to track one or more of the additional harmonic frequencies.

49. A method for monitoring multiple harmonic frequencies, comprising;
tracking two or more selected harmonic frequencies of a fundamental frequency using two or more FLL/PLLs; and
adjusting a local oscillator (LO) of each of the FLL/PLLs to track one or more of the distinct frequencies chosen from the additional harmonic frequencies.

50. The method of claim 48, further comprising tuning a center frequency of a filter to detect an actual power grid frequency using a FLL/PLL tracking frequency of the LO.

51. The method of claim 49, further comprising tuning a center frequency of a filter to detect an actual power grid frequency using a FLL/PLL tracking frequency of the LO.
